(19) United States
(12) Patent Application Publication
(10) Pub. No.: US 2014/0040004 A1
(43) Pub. Date: Feb. 6, 2014

(54) IDENTIFYING A DEAL IN SHOPPING RESULTS

(71) Applicants: Yaniv HAMO, Adliswil (CH); Mohamad Hassan Mohamad Rom, Zurich (CH); Regina O'Dell, Zurich (CH); Ankit Gupta, Zurich (CH); Tom Beyer, Ruschlikon (CH); Michaela Feller, San Francisco, CA (US)

(72) Inventors: Yaniv HAMO, Adliswil (CH); Mohamad Hassan Mohamad Rom, Zurich (CH); Regina O'Dell, Zurich (CH); Ankit Gupta, Zurich (CH); Tom Beyer, Ruschlikon (CH); Michaela Feller, San Francisco, CA (US)

(73) Assignee: GOOGLE Inc., Mountain View, CA (US)

(21) Appl. No.: 13/565,777

(22) Filed: Aug. 2, 2012

(51) Int. Cl. G06Q 30/02

(52) U.S. Cl. 705/14.35

(57) ABSTRACT

A shopping system can employ a computer-implemented method to determine whether an offer is a deal. The method comprises associating offers received for a product with the product in a database; associating a time for each of the offers noting when each particular offer was effective; receiving a current offer for the product; identifying the offers for the product in the database that are within a configured time period of the current offer; comparing the offers for the product in the database with the current offer for the product based on a set of parameters; identifying the current offer as a deal in response to a determination that the current offer satisfies all parameters compared to the offers for the product in the database. Various sets of parameters may be used to determine if the current offer is a deal with respect to previous offers.

### TECHNICAL FIELD

The present disclosure relates to online shopping queries, and more particularly to a method for identifying a deal associated with the search results of a shopping query.

### BACKGROUND

The retail market has seen significant growth in online shopping since the advent of the Internet. On the Internet, users may search for, locate, and purchase nearly everything that can be purchased at a physical marketplace.

Online shopping websites often use shopping search engines to allow a user to search for a specific product or group of products. The online shopping system employing the search engines stores information regarding products and characteristics of each product. For example, a search engine or the online shopping system may store a database of products that contains product descriptions, product user ratings, merchants offering the products, product identifications, such as a model number, and other product characteristics.

An online shopping system may additionally store offers for the product, such as coupons, discounts, rebates, or other offers. The offer details may be provided to the search engine by offer providers, such as the marketing system for the product, retailers, “daily deal” offer providers, and others. An online shopping system can use a search engine to perform a web search to gather current offers and product information from product websites, retailers, and other shopping websites.

When a user receives product offers, the user desires to know if an offer is a deal. A deal is generally described as an offer for a product that has a price that is substantially less than the accustomed price. Users may experience difficulties while attempting to determine if an offer is a deal or not. For example, an offer that states that a product is 20% off of the listed price may seem to be a deal to many users. However, the user may not be aware that the offer provider is offering 20% off of an artificially inflated price and not 20% off of the accustomed price that has been offered frequently or by other offer providers.

Certain shopping websites have begun to offer historical pricing information for a user to review. The charts and graphs that may present the historical graph rely upon the user for interpretation. The user may not be positioned to make a proper interpretation of the data. Additionally, the data may not be presented in a format that is scaled for a proper determination of a deal. For example, the time frame of the chart may be too large or small to make a proper determination of a deal.

Certain shopping websites make predictions, based on the historical pricing, about whether the product price will decrease or increase in the future. The prediction does not tell the user if the current offer of a product is a deal. The prediction only tells the user if the shopping site believes the price will go up or down. The user may desire to know if the current offer is a deal and may not be interested in future price variations.

Users may desire an automated method of determining if an offer is a deal without the need to examine price charts and historical pricing data. The user may additionally desire to be notified of deals that might be of interest to them.

### SUMMARY

An aspect of the present invention provides a computer-implemented method to identify a deal in an online shopping query. The method comprises associating offers received for a product with the product in a database; associating a time of receipt for each of the offers; receiving a current offer for the product; identifying the offers for the product in the database that are within a configured time period of the current offer; comparing the offers for the product in the database with the current offer for the product based on a set of parameters; identifying the current offer as a deal in response to a determination that the current offer satisfies all parameters compared to the offers for the product in the database. Numerous sets of parameters may be used to determine if an offer is a deal.

Another aspect of the present invention provides a computer program product that is installed on a server located in a search engine system to identify a deal in an online shopping query. The computer program product includes a non-transitory computer-readable storage device having computer-readable program instructions stored therein. The computer-readable program instructions include computer program instructions for associating offers received for a product with the product in a database; associating a time of receipt for each of the offers; receiving a current offer for the product; identifying the offers for the product in the database that are within a configured time period of the current offer; comparing the offers for the product in the database with the current offer for the product based on a set of parameters; identifying the current offer as a deal in response to a determination that the current offer satisfies all parameters compared to the offers for the product in the database. Numerous sets of parameters may be used to determine if an offer is a deal.

These and other aspects, objects, features and advantages of the exemplary embodiments will become apparent to those having ordinary skill in the art upon consideration of the following detailed description of illustrated exemplary embodiments, which include the best mode of carrying out the invention as presently presented.

### BRIEF DESCRIPTION OF THE DRAWINGS

FIG. 1 is a block diagram depicting a system for identifying a deal in an online shopping query, in accordance with certain exemplary embodiments.

FIG. 2 is a block flow diagram depicting a method for identifying a deal, in accordance with certain exemplary embodiments.

FIG. 3 is a block flow diagram depicting a method for an online shopping system to identify a particular offer for a product as a deal, in accordance with certain exemplary embodiments.

FIG. 4 is a block flow diagram depicting a method for an online shopping system to identify a particular offer for a product as a deal, in accordance with certain exemplary embodiments.

### DETAILED DESCRIPTION OF THE EXEMPLARY EMBODIMENTS

### Overview

The exemplary embodiments provide an online shopping system that employs a search engine. The online shopping system may employ a user interface to allow a user to enter keywords or phrases into the search engine. The keywords may be a single word relating to the product for which the user would like to shop, two or more related words, or a phrase relating to the product. As used throughout the specification, any combination of one or more keywords or phrases will be referred to simply as “keywords”. As used throughout the specification, the term “product(s)” should be interpreted to include tangible and intangible products, as well as services. The user may also enter product model numbers or other identifiers to search for a specific product.

The online shopping system maintains a database or other catalog of products. The online shopping system can receive offers from online offer providers or other product marketers. The offer providers may be marketing systems for a product, product manufacturers, retailers, “daily deal” offer providers, and others. The offer providers may transmit offers and other product information to the search engine system.

Additionally or alternatively, the search engine of the online shopping system can traverse the Internet and gather deals, coupons, promotions, and other offers from the websites of offer providers and other suitable locations and store the products and offers in the database.

Additionally or alternatively, the search engine can conduct a web search over the Internet and gather offers and product details at the time of the query entry. The search engine can extract offers from the search results.

The online shopping system can utilize a deal application operating on the web server of the online shopping system to analyze each offer for a product. The deal application additionally gathers the price history of the product over a predetermined period of time, such as 90 days, 120 days, or any other time period. The deal application can compare the current offers for the products to the price history of the product and determine if any of the current offers are a deal.

An offer may be a deal if the product is being offered for a price that is a predetermined amount less than the accustomed price. The search engine system can use various analysis techniques for assessing the accustomed price for the product. The accustomed price is generally considered to be the price that a user would expect to pay for a product. The accustomed price may alternatively be considered what users may commonly consider a fair price. The accustomed price may alternatively be what the market considers a product to be worth.

Various methods and techniques may be employed by the online shopping system to determine if the current offer is a deal. Within the various methods, the online shopping system operators, users, or others can vary the parameters of the methods and techniques to better match the user's perception of a deal. Following are two examples of methods that may be employed to identify a deal.

In one example of a method to identify a deal based on the price history, the search engine can identify the prices for which the product has been offered over a period of time, such as 90 days, 120 days, or any other suitable time period. The search engine can determine the minimum price over that time period. The deal application can additionally require that the most recent occurrence of the minimum price of the time period occurred within a configured time in the past, such as within the last 15 days, 30 days, or any other suitable time period. The deal application can compare the current offer to the minimum price and determine if the minimum price in the price history exceeds the current offer by a configured percentage, such as 10%, 20% or any other suitable percentage. In an example, if a the minimum price of the last 90 days is more than 10% greater than the current offer, and the latest occurrence of the minimum price occurred in the last 30 days, then the current offer may be a deal. The time periods and the configured percentages may be varied by a user or the online shopping system to achieve a certain goal or meet the requirements of a user or a group of users. Alternatively, the method may use a threshold value instead of a percentage to identify a deal. For example, the current offer may be determined to be a deal if the current offer is more than $50, $100, or any other suitable dollar value lower than the determined minimum price regardless of the percentage difference.

In another example of a method to identify a deal based on the price history, the deal application can identify the prices for which the product has been offered over a period of time, such as 90 days, 120 days, or any other suitable time period. The search engine can determine the average price of the product over that time period. The deal application can compare the current offer to the average price and determine if the average price exceeds the current offer by a configured percentage, such as 10%, 20% or any other suitable percentage. In an example, if the average price of the last 90 days is more than 10% greater than the current offer, then the current offer is identified as a deal. The time periods and the configured percentages may be varied by a user or the online shopping system to achieve a certain goal or meet the requirements of a user or a group of users. Alternatively, the method may use a threshold value instead of a percentage to identify a deal. For example, the current offer may be determined to be a deal if the current offer is more than $50, $100, or any other suitable dollar value lower than the calculated average price.

Other methods of comparing the current offer to the price history of the product may be employed to identify a deal.

In the exemplary embodiment, the deal application designates the current offer as a deal or not a deal. In an alternate embodiment, the deal application can assign a total score to an offer based on whether the offer is a deal or not. For example, the deal application can give a ranking of a deal from 1 to 10 or give a letter grade to a deal based on the comparison of the current offer to the price history. The score may be based on the magnitude of the deal or on the confidence of the method that the current offer is a deal. The ranking can alternatively be a thumbs up or thumbs down or any other scale or scoring system.

The website can display the results of the search and the status of each offer as a deal or not a deal. The results can be displayed to the user to assist the user in selecting the best offer for a product. A current offer can have a symbol or badge attached to the offer denoting a deal.

In an alternative embodiment, the online shopping system can provide a list of all current deals to a user based on the history of the user. That is, the online shopping system can access items from the user history such as purchasing history, keyword searches, links clicked, ads converted, websites accessed, or any other usable data from the user history. The online shopping system can determine if a deal may be related to the user history and provide the deal to the user. The online shopping system may provide the deal to the user in an email, text, advertisement, or any other suitable manner. The online shopping system may additionally or alternatively present the deals associated with the history of a user to the user as a display on the online shopping system website. For example, the website of the online shopping system can employ a section of the display to list current deals in which a user may be interested when the user opens the online shopping system website.

In an alternate embodiment, the online shopping system can offer all current deals in a separate database or webpage for access by the user. For example, the website can present a “deals only” section that allows a user to perform a shopping search of only products that are currently considered to be deals by the deal application.

The online shopping system can present a current offer that is determined to be a deal to the user in any other suitable fashion.

The functionality of the exemplary embodiments will be explained in more detail in the following description, read in conjunction with the figures illustrating the program flow.

### System Architecture

Turning now to the drawings, in which like numerals represent like (but not necessarily identical) elements throughout the figures, exemplary embodiments of the invention are described in detail.

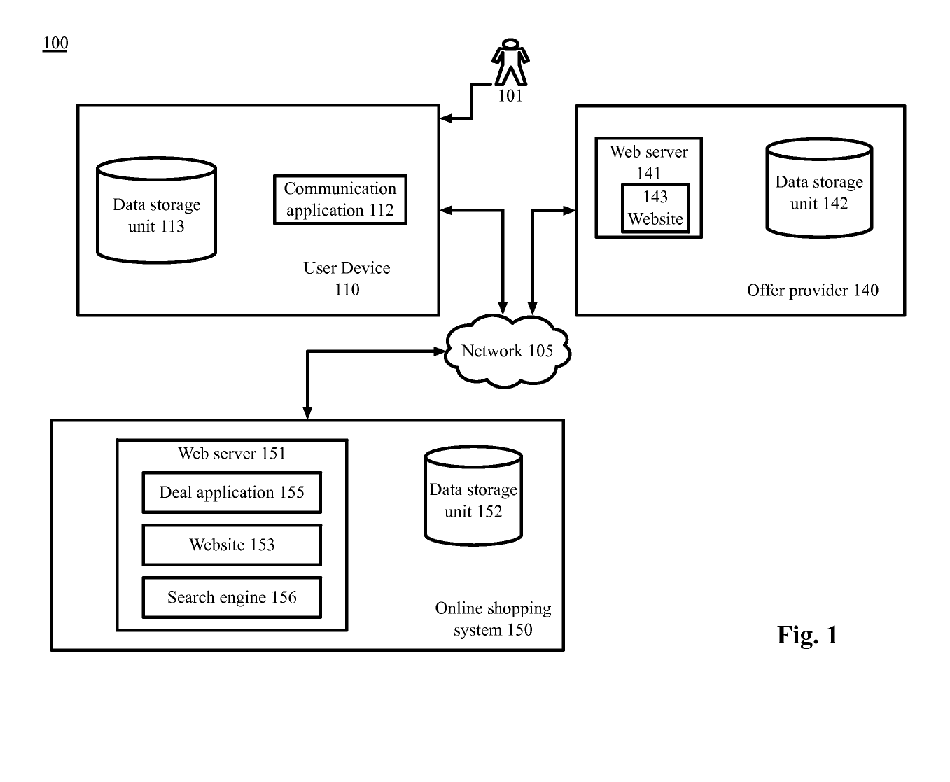

FIG. 1 is a block diagram depicting a system 100 for identifying a deal in an online shopping query, in accordance with certain exemplary embodiments.

As depicted in FIG. 1, the system 100 includes network devices 110, 140, and 150 that are configured to communicate with one another via one or more networks 105.

Each network 105 includes a wired or wireless telecommunication means by which network devices (including devices 110, 140, and 150) can exchange data. For example, each network 105 can include a local area network (“LAN”), a wide area network (“WAN”), an intranet, an Internet, a mobile telephone network, or any combination thereof. Throughout the discussion of exemplary embodiments, it should be understood that the terms “data” and “information” are used interchangeably herein to refer to text, images, audio, video, or any other form of information that can exist in a computer-based environment.

Each network device 110, 140, and 150 includes a device having a communication module capable of transmitting and receiving data over the network 105. For example, each network device 110, 140, and 150 can include a server, desktop computer, laptop computer, tablet computer, smart phone, handheld computer, personal digital assistant (“PDA”), or any other wired or wireless, processor-driven device. In the exemplary embodiment depicted in FIG. 1, the network devices 110, 140, and 150 are operated by end-users or consumers, offer provider operators, and online shopping system operators, respectively.

The user 101 can use the communication application 112, such as a web browser application or a stand-alone application, to view, download, upload, or otherwise access documents or web pages via a distributed network 105. The network 105 includes a wired or wireless telecommunication system or device by which network devices (including devices 110, 140, and 150) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages.

The user device 110 includes a data storage unit 113 accessible by the communication application 112. The exemplary data storage unit 113 can include one or more tangible computer-readable media. The data storage unit 113 can be stored on the user device 110 or can be logically coupled to the user device 110. For example, the data storage unit 113 can include on-board flash memory and/or one or more removable memory cards or removable flash memory.

The online shopping system 150 utilizes an online shopping system web server 151. The online shopping system server 151 may represent the computer implemented system that the online shopping system 150 employs to configure user accounts, create the online marketplace, host the search engine 156, communicate with or host the search engine 156, and complete transactions with the user device 110. The online shopping system website 153 may represent any web-based interface that allows users to interact with the online shopping system 150 to search for products, browse products, and make purchases. The online shopping system 150 may include a data storage unit 152 accessible by the server 151 of the online shopping system 150. The data storage unit 152 can include one or more tangible computer-readable storage devices.

The search engine 156 can operate on the web server 151 and can be used to search the Internet for websites and other Internet accessible data for the purpose of online shopping or other online searching functions. The search engine 156 may collect the websites or other online locations of the searched product and display the results to the user. The search engine 156 can be configured to interact with one or more offer provider system 140 to search documents, websites, and other data, submit search results and query suggestions, store product databases, and store product offers.

The online shopping system website 153 may represent any web-based interface that allows users to interact with the online shopping system 160 to enter search data and receive search results and ranked lists of offers. The search engine 156 user interface can interact with the website 153 or be embodied as a companion application of the website application and execute within the website application. In certain exemplary embodiments, the search engine 156 can be implemented in a stand-alone configuration in which the user 101 can search multiple merchant online shopping systems 150. In certain exemplary embodiments, the search engine 156 can operate on a remote server or a server that is not part of the online shopping system 150. The search engine 156 may be accessed by the online shopping system 150 and presented to the user 101 via the online shopping system website 151.

The deal application 155 may operate on the web server 151 or in any way be accessed by the web server 151. The deal application may be configured to access current offers and compare the current offers with the price history of a product. The deal application can identify deals and provide the deal identification to the search engine 156, the website 153, any other function of the online shopping system, directly to the user 101, or to any other suitable recipient.

The offer provider 140 can employ an offer provider web server 141. The server 141 may represent the computer implemented system that the offer provider 140 employs to host the offer provider website 143. The offer provider website 143 may host the offers for which the search engine 156 is searching. The offer provider may host offers, sales, retail outlets, daily deals, product manufacturers, product marketing systems, or other system that is related to the product being searched and can provide products for purchase or offers for a product. The offer provider 140 may transmit offers and other product information to the search engine via a message over the network 105, email, text, or any other suitable connection. The offer provider 140 may include a data storage unit 142 accessible by server 141 of the offer provider 140. The data storage unit 142 can include one or more tangible computer-readable storage devices.

It will be appreciated that the network connections shown are exemplary and other means of establishing a communications link between the computers and devices can be used. Moreover, those having ordinary skill in the art having the benefit of the present disclosure will appreciate that the user device 110, offer provider 140, and online shopping system 150 illustrated in FIG. 1 can have any of several other suitable computer system configurations. For example, a user device 110 can be embodied as a mobile phone or handheld computer may not include all the components described above.

### System Process

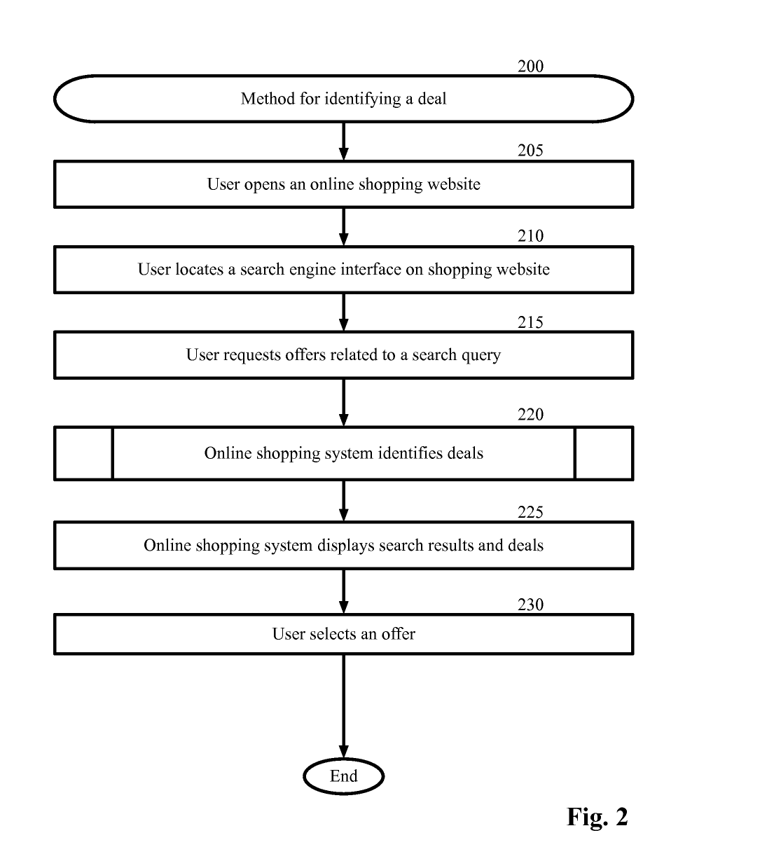

The components of the exemplary operating environment 100 are described hereinafter with reference to the exemplary methods illustrated in FIGS. 2-4.

FIG. 2 is a flow chart depicting a method 200 for identifying a deal, in accordance with certain exemplary embodiments.

With reference to FIGS. 1 and 2, in block 205, the user 101 opens a website 153 on an online shopping system 150. The user may access the website 153 by a mobile network device, (for example, notebook computer, tablet computer, netbook computer, personal digital assistant (PDA), video game device, GPS locator device, cellular telephone, smartphone, or other mobile device), a personal computer, or other appropriate technology that includes or is coupled to a communication application 112, such as GOOGLE'S CHROME, MICROSOFT'S INTERNET EXPLORER, or MOZILLA'S FIREFOX.

In block 210, the user 101 locates a search engine user interface on the online shopping website 153. The search engine 156 may be embodied as a companion application of the website 153 and execute within the website 153 application. Alternatively, in an alternate embodiment, the website 153 may simply host the user interface of the search engine 156 and allow the search engine 156 to operate as a separate application. Alternatively, the search engine 156 may be a function of the online shopping system 150. Alternatively, the online shopping system 150 may be a function of the search engine 156.

In block 215, the user 101 utilizes a user interface of the website 153 to enter a keyword or phrase relating to the item for which they are searching. The keywords may be a single word relating to the product for which the user would like to shop, two or more related words, or a phrase relating to the product. As used throughout the specification, any combination of one or more keywords or phrases will be referred to simply as “keywords”. The user 101 may enter further details about a product to identify the product such as a model number, part number, or other description.

In block 220, the deal application 155 operating on the online shopping system 150 identifies offers associated with the shopping query that are determined to be deals. The deal application 155 is configured to analyze each offer for a product. The deal application 155 additionally gathers the price history of the product over a predetermined period of time, such as 90 days or 120 days. The deal application 155 can compare the current offers for the products to the price history of the product and determine if any of the current offers are a deal.

An offer may be a deal if the product is being offered for a price that is a predetermined amount less than the accustomed price. The search engine system can use various analysis techniques for assessing the accustomed price for the product. The accustomed price is generally considered to be the price that a user would expect to pay for a product. The accustomed price may alternatively be considered what users may commonly consider a fair price. The accustomed price may alternatively be what the market considers a product to be worth.

Various methods and techniques may be employed by the online shopping system 155 to determine if the current offer is a deal. Within the various methods, the online shopping system operators, users 101, or others can vary the parameters of the methods and techniques to better match the user's perception of a deal.

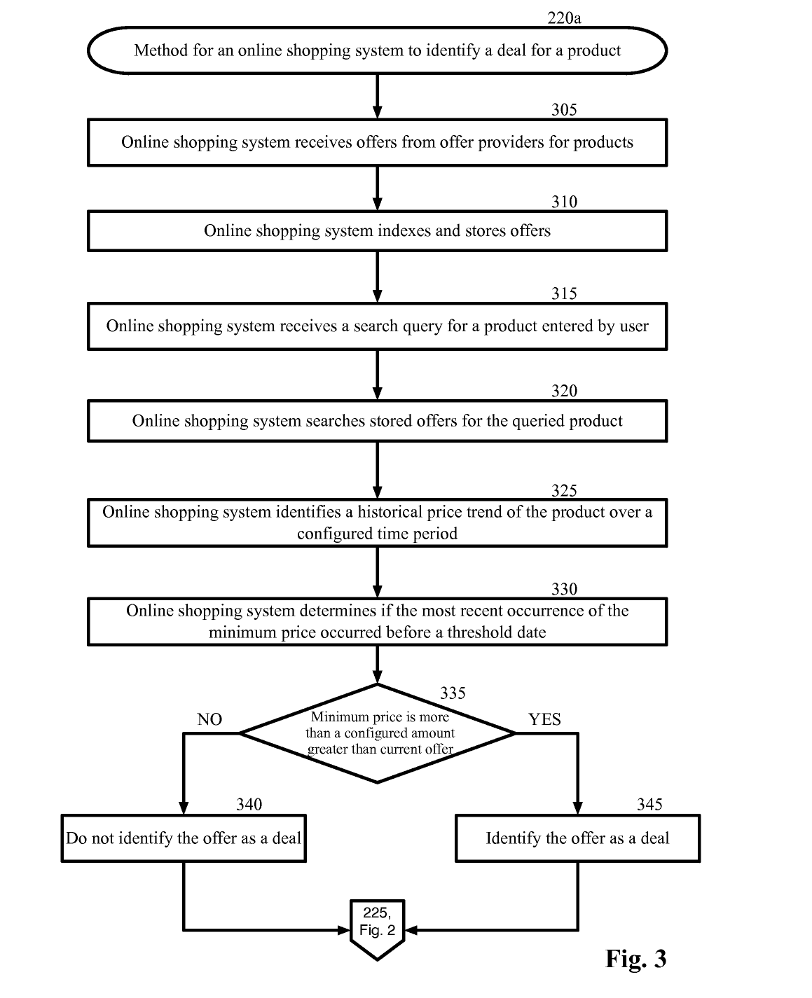

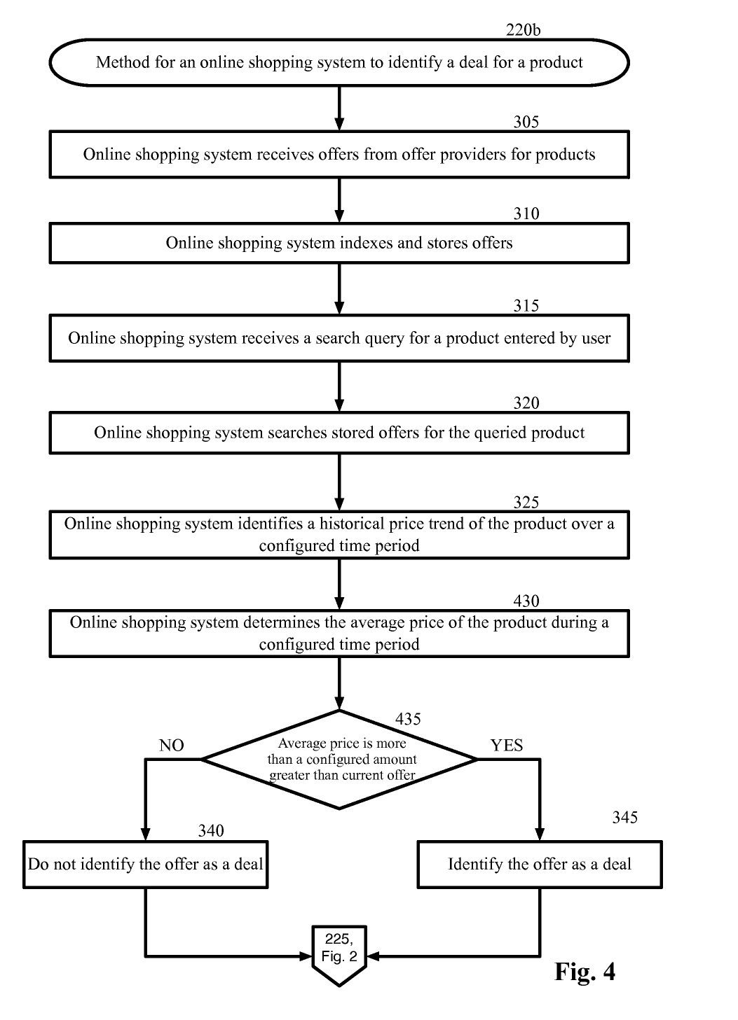

FIG. 3 and FIG. 4 depict two exemplary methods, 220a and 220b, for an online shopping system 150 to identify whether a particular offer is a deal. Methods 220a and 220b are not intended to represent the only methods that the deal application 155 might employ, but are presented as just two examples of how the deal application 155 could be configured to identify whether a particular offer is a deal.

FIG. 3 is a flow chart depicting a method 220a for an online shopping system 150 to identify whether a particular offer is a deal for a product in an online shopping query, in accordance with certain exemplary embodiments.

In block 305, the search engine 156 of the online shopping system 150 receives or gathers offers and product details from offer providers 140. The search engine 156 can receive offers from online offer providers 140. The offer provider 140 may be a marketing system for a product, retailers, “daily deal” offer providers, and others. The offer providers 140 may transmit offers and other product information to the search engine 156.

Additionally or alternatively, the search engine 156 can traverse the Internet and gather deals, coupons, promotions, and other offers from the websites of offer providers 140 and other suitable locations and store the products and offers in the database.

Additionally or alternatively, the search engine 156 can conduct a web search over the Internet and gather offers and product details at the time of the query entry. The search engine 156 can extract offers from the search results.

The offer provider 140 may transmit offers and other product information to the search engine 156 via a message over the network 105, email, text, or any other suitable connection.

In block 310, the search engine 156 maintains a database or other catalog of products. The search engine 156 analyzes each offer for a product. Some offers may include a sale price, a rebate, a coupon, free or discounted installation, free or discounted warranties, “buy one get one free” offers, included accessories, or other types of offers.

Additionally or alternatively, the database may be maintained on the online shopping system 150 if the search engine 156 is not a function of the online shopping system 150. That is, if the online shopping system 150 employs a search engine 156 that operates on a different server or on another system, the online shopping system 150 may maintain the database. The online shopping system 150 may employ the search engine 156 or other service to update or service the database.

In block 315, the search engine 156 on the online shopping system 150 receives a search query from a user 101, as discussed previously with reference to block 215 of FIG. 2. The user 101 enters the search query into the user interface provided by the search engine 156 or the online shopping system 150.

In block 320, the search engine 156 can access the products and the related offers stored in the database that most closely match the search query. The search engine 156 can alternatively or additionally perform a search of the Internet for offers and merchants at the time of the search query.

In block 325, the deal application 155 on the online shopping system 150 produces a historic price trend for one or more of the products identified by the search engine 156. The deal application 155 can gather the historic prices from data stored on the database, gathered by the search engine 156 at the time of the query, stored by the web server 151 in a separate database, or any other suitable location. The deal application 155 can be configured to vary the features of the prices and products as needed. For example, the deal application 155 can be configured to gather the prices for a certain time period, for only a specific product, for a group of products, for a certain merchant or group of merchants, or for any other configured characteristic.

In block 330 the deal application 155 can determine if the most recent occurrence of the minimum price occurred more than a configured amount of time prior to the current deal. For example, if the time period is 90 days, the deal application 155 can review the prices of the product for one or more merchants over the 90 days and determine the lowest price for which the product has been offered. If the deal application 155 has access to the final purchase price, then that information may additionally or alternatively be utilized. Any other time period may be configured to conform to the expectations of the user 101 or other operator. For example, a user 101 or other operator may only desire to compare the current offer to prices from the last 30 days. A shorter time period may be more useful for a product that has a price that changes rapidly. In another example, a user 101 or other operator may desire to compare the current offer to prices from the previous year. A longer time period may be more useful for a product that has a price that seldom changes. Any other suitable time period may be configured to conform the Method 220a to meet the expectations of the user 101 or other operator.

The user 101 or other operator can configure the maximum amount of time prior to the current offer for the most recent occurrence of the minimum price to ensure that the price has not been artificially inflated in preparation for the current offer. For example, the deal application 155 can determine if the most recent occurrence of the minimum price occurred more than 30 days prior to the search request. Any other amount of time prior to the current deal can be configured such as 1 day, 15 days, 100 days, or any other suitable amount of time.

If the most recent occurrence of the minimum price is within the configured amount of time prior to the current deal, then the method 220a follows the “YES” branch of block 330 to block 335. If the most recent occurrence of the minimum price is outside of the configured amount of time prior to the current deal, then the method 220a follows the “NO” branch of block 330 to block 340.

In block 335, the deal application 155 can compare the current offer of the product to the minimum price that meets all of the time requirements. The deal application 155 can determine if the minimum price is more than a configured amount greater than the current offer. For example, the deal application 155 may be configured to determine if the minimum price is more than 10% greater than the current offer. In other examples, the deal application 155 may be configured to determine if the minimum price is more than 5%, 20%, 50% or any other suitable amount greater than the current offer.

In another example, the method 220a may use a threshold value instead of a percentage to identify a deal. For example, the current offer may be determined to be a deal if the current offer is more than a threshold dollar value less than the determined minimum price. Any suitable threshold amount may be configured, such as $50, $100, $1000, or any other dollar value.

In another example, the threshold may be equal to the determined minimum price. That is, the current offer may be a deal if the current price is any dollar value or percentage less than the determined minimum price.

If the minimum price is more than a configured amount greater than the current offer, then the method 220a follows the “YES” branch of block 335 to block 345. If the minimum price is less than a configured amount greater than the current offer, then the method 220a follows the “NO” branch of block 335 to block 340.

The time periods and the configured percentages and threshold values may be varied by a user 101 or the online shopping system 150 to achieve a certain goal or meet the requirements of a user 101 or a group of users.

Following the “NO” branches of block 335 and block 330 to block 340, the deal application 155 identifies the current offer as not being a deal. The deal application 155 may inform the online shopping system 150 of the deal status of the current offer, label or otherwise denote the deal status of the offer in the database, take any other suitable action, or take no action at all.

Following the “YES” branch of block 335 to block 345, the deal application 155 identifies the current offer as a deal. The deal application 155 may inform the online shopping system 150 of the deal status of the current offer, label or otherwise denote the deal status of the offer in the database, or take any other suitable action to identify the deal status of the current offer as a deal.

From block 340 and block 345 the method 220a returns to block 225 of FIG. 2.

FIG. 4 is a flow chart depicting a method 220b for an online shopping system 150 to identify whether a particular offer is a deal for a product in an online shopping query, in accordance with certain alternative exemplary embodiments.

Blocks 305 to 325 of method 220b are substantially the same as blocks 305 to 325 of method 220a described previously with reference to FIG. 3.

In block 430, the deal application 155 of the online shopping system 150 can identify the average price of the product over the specified time period. For example, if the time period is 90 days, the deal application 155 can review the prices of the product for one or more merchants over the 90 days prior to the current offer and determine the average price for which the product has been offered. Any other amount of time prior to the current deal can be configured such as 1 day, 15 days, 100 days, or any other suitable amount of time. If the deal application 155 has access to the final purchase price for the product, then that information may additionally or alternatively be utilized.

In block 435, the deal application 155 can compare the current offer of the product to the average price over the configured time period. The deal application 155 can determine if the average price is more than a configured amount greater than the current offer. For example, the deal application 155 may be configured to determine if the average price is more than 10% greater than the current offer. In other examples, the deal application 155 may be configured to determine if the average price is more than 5%, 20%, 50% or any other suitable amount greater than the current offer.

In another example, the method 220b may use a threshold value instead of a percentage to identify a deal. For example, the current offer may be determined to be a deal if the current offer is more than a threshold dollar value less than the average price. Any suitable threshold amount may be configured, such as $50, $100, $1000, or any other dollar value.

In another example, the threshold may be equal to the average price. That is, the current offer may be a deal if the current price is any dollar value or percentage less than the average price.

If the average price is more than a configured amount greater than the current offer then the method 220b follows the “YES” branch of block 435 to block 345. If the average price is less than a configured amount greater than the current offer then the method 220b follows the “NO” branch of block 435 to block 340.

The time periods and the configured percentages may be varied by a user 101 or the online shopping system 150 to achieve a certain goal or meet the requirements of a user 101 or a group of users.

Block 340 and block 345 of method 220b are substantially the same as block 340 and block 345, respectively, of method 220a described previously with reference to FIG. 3.

From block 340 and block 345 the method 220b returns to block 225 of FIG. 2.

Returning to block 225 of FIG. 2, after receiving the identity of offers that are deals associated with the shopping query, the deal application 155 provides the deals to the user 101. The website 153 can display the results of the search and the status of each offer as a deal or not a deal. The results can be displayed to the user 101 to assist the user 101 in selecting the best offer for a product. A current offer can have a symbol or badge attached to the offer denoting a deal.

The website 153 can display the methodology used to determine the deal or other explanation of the designation of a deal. The website 153 can display the historic price to which the current offer is being compared. For example, in method 220a, the website 153 can display the minimum price to which the current offer is compared. In method 220b, the website 153 can display the average price to which the current offer is compared. The website 153 can additionally show the current offer along with the minimum or average price in any format, such as a numerical display, graphical display, or other display.

The website 153 may present features of the method or the calculation process to the user 101. For example, the website 153 may present a graphical display of the price of the product during the time period of the method along with the price of the current offer. Any other feature of the method may be displayed to allow the user 101 to better understand the method and the quality of the deal.

The website 153 can additionally or alternatively display the configured thresholds and time frames used to identify a particular offer as a deal. For example, the website 153 might display the percentage by which the current offer must beat a minimum or average price to be identified as a deal. The website 153 might display the time frame used to identify the minimum price or average price of the historic prices. Additionally or alternatively, the website 153 may provide an interactive display that allows the user 101 to alter or configure the factors used to identify a deal, such as the time period or the percentage by which the current offer must beat a minimum or average price to be identified as a deal.

In an alternative embodiment, the online shopping system 150 can provide a list of all current deals to a user 101 based on the history of the user 101. That is, the online shopping system 150 can access items from the user's history, such as purchasing history, keyword searches, links clicked, ads converted, websites accessed, or any other usable data from the user history. The online shopping system 150 can determine, using the exemplary embodiments described in FIGS. 3 and 4, if a deal is related to the user history and can provide the deal to the user 101. The online shopping system 150 may provide the deal to the user 101 in an email, text, advertisement, application, or any other suitable manner. The online shopping system 150 may present the deals associated with the history of a user 101 to the user 101 as a display on the online shopping system website 153. For example, the website 153 of the online shopping system 150 can employ a section of the display to list current deals in which a user 101 may be interested when the user 101 opens the online shopping system website 153.

In addition to the history of the user 101, the online shopping system 150 can present deals to a user 101 based on user preferences known by the online shopping system 150. The user preferences may include factors such as gender, social network information, gender, location, shopping habits, or any other suitable factor.

In an alternate embodiment, the online shopping system 150 can offer all current deals in a separate database or webpage for access by the user 101. For example, the website 153 can present a “deals only” section that allows a user 101 to perform a shopping search of only products that are currently considered to be deals by the deal application 155.

The online shopping system 150 can present a deal on a product to the user 101 in any other suitable fashion.

In block 230, the user 101 can select the offer or other deal that most closely matches the result for which the user 101 was shopping.

From block 230, the method 200 ends.

### General

Users may be allowed to limit or otherwise affect the operation of the features disclosed herein. For example, users may be given opportunities to opt-in or opt-out of the collection or use of certain data or the activation of certain features. In addition, users may be given the opportunity to change the manner in which the features are employed. Instructions also may be provided to users to notify them regarding policies about the use of information, including personally identifiable information, and manners in which each user may affect such use of information. Thus, information can be used to benefit a user, if desired, through receipt of relevant advertisements, offers, or other information, without risking disclosure of personal information or the user's identity.

One or more aspects of the invention may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as the act may be performed by more than one computer

The exemplary embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The exemplary systems, methods, and acts described in the embodiments presented previously are illustrative, and, in alternative embodiments, certain acts can be performed in a different order, in parallel with one another, omitted entirely, and/or combined between different exemplary embodiments, and/or certain additional acts can be performed, without departing from the scope and spirit of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for identifying whether an offer is a deal, comprising:
monitoring, by a computer, a plurality of offers for a product during a configured time period, each of the offers comprising a price for the product and a time during which respective offer is valid;
associating, by the computer, the offers with the product in a database;
selecting, by a computer, a current offer for the product, the current offer comprising a price for the product and a time during which the current offer is valid;
identifying, by the computer, the offers for the product in the database that are within a configured time period of the current offer;
determining, by the computer, an average price for the product, wherein the average price is an average of the prices of the offers that are within the configured time period of the current offer;
determining, by the computer, if the price of the current offer is less than a configured threshold below the average price;
identifying, by the computer, the current offer as a deal in response to a determination that the current offer is less than a configured threshold below the average price; and
identifying, by the computer, the current offer as not being a deal in response to a determination that the current offer is not less than a configured threshold below the average price.

2. The computer-implemented method of claim 1, further comprising:
receiving, by the computer, a shopping query from a user network device, wherein the query is associated with the product; and
communicating, by the computer, the current offer identified as a deal to the user network device in response to receiving the query.

3. The computer-implemented method of claim 1, wherein the threshold is a configured percentage of the average price, is a configured dollar value less than the average price, or is equal to the average price.

4. The computer-implemented method of claim 1, wherein the computer transmits the current offer to a network device of a user in response to an identification of the current offer as a deal.

5. The computer-implemented method of claim 1, wherein the current offer identified as a deal is transferred to a network device of the user based on a determination that the product is related to the history of the user.

6. The computer-implemented method of claim 1, wherein the computer executes an online shopping website.

7. The computer-implemented method of claim 1, further comprising displaying, by the computer, the current offer with an indication that the current offer is a deal in response to the computer identifying the current offer as a deal.

8. The computer-implemented method of claim 1, further comprising displaying, by the computer, the current offer in relation to the average price.

9. The computer-implemented method of claim 1, further comprising displaying, by the computer, the current offer and the prices of the offers that are within the configured time period of the current offer in graphical form.

10. A computer-implemented method for identifying whether an offer is a deal, comprising:
monitoring, by a computer, a plurality of offers for a product during a configured time period, each of the offers comprising a price for the product and a time during which respective offer is valid;
associating, by the computer, the offers with the product in a database;
selecting, by a computer, a current offer for the product, the current offer comprising a price for the product and a time during the which current offer is valid;
identifying, by the computer, the offers for the product in the database that are within a configured time period of the current offer;
determining, by the computer, an offer with a minimum price for the product, wherein the minimum price is the minimum price of the offers that are within the configured time period of the current offer;
determining, by the computer, if the price of the current offer is less than a configured threshold below the minimum price;
identifying, by the computer, the current offer as a deal in response to a determination that the current offer is less than a configured threshold below the minimum price; and
identifying, by the computer, the current offer as not being a deal in response to a determination that the current offer is not less than a configured threshold below the minimum price.

11. The computer-implemented method of claim 10, further comprising:
receiving, by the computer, a shopping query from a user network device, wherein the query is associated with the product; and
communicating, by the computer, the current offer identified as a deal to the user network device in response to receiving the query.

12. The computer-implemented method of claim 10, wherein the threshold is a configured percentage of the minimum price, is a configured dollar value less than the minimum price, or is equal to the minimum price.

13. The computer-implemented method of claim 10, wherein the computer transmits the current offer to a network device of a user in response to an identification of the current offer as a deal.

14. The computer-implemented method of claim 10, wherein the current offer identified as a deal is transferred to a network device of the user based on a determination that the product is related to the history of the user.

15. The computer-implemented method of claim 10, wherein the computer executes an online shopping website.

16. The computer-implemented method of claim 10, further comprising displaying, by the computer, the current offer with an indication that the current offer is a deal in response to the computer identifying the current offer as a deal.

17. The computer-implemented method of claim 10, further comprising displaying, by the computer, the current offer in relation to the minimum price.

18. The computer-implemented method of claim 10, further comprising displaying, by the computer, the current offer and the prices of the offers that are within the configured time period of the current offer in graphical form.

19. A computer program product, comprising:
a non-transitory computer-readable storage device having computer-executable program instructions embodied thereon that when executed by a computer identify whether an offer is a deal, the computer-executable program instructions comprising:
computer-executable program instructions to monitor a plurality of offers for a product during a configured time period, each of the offers comprising a price for the product and a time during which respective offer is valid;
computer-executable program instructions to select a current offer for the product, the current offer comprising a price for the product and a time during the which current offer is valid;
computer-executable program instructions to identify the offers for the product in the database that are within a configured time period of the current offer;
computer-executable program instructions to determine an offer with a minimum price for the product, wherein the minimum price is the minimum price of the offers that are within the configured time period of the current offer;
computer-executable program instructions to determine if the price of the current offer is less than a configured threshold below the minimum price;
computer-executable program instructions to identify the current offer as a deal in response to a determination that the current offer is less than a configured threshold below the minimum price; and
computer-executable program instructions to identify the current offer as not being a deal in response to a determination that the current offer is not less than a configured threshold below the minimum price.

20. The computer program product of claim 19, further comprising:
computer-executable program instructions to receive a shopping query from a user network device, wherein the query is associated with the product; and
computer-executable program instructions to communicate the current offer identified as a deal to the user network device in response to receiving the query.

21. The computer program product of claim 19, the threshold is a configured percentage of the minimum price, is a configured dollar value less than the minimum price, or is equal to the minimum price.

22. The computer program product of claim 19, further comprising computer-executable program instructions to transmit the current offer to a network device of a user in response to an identification of the current offer as a deal.

23. The computer program product of claim 19, wherein the current offer identified as a deal is transferred to the network device of the user based on a determination that the product is related to the history of the user or an identified preference of the user.

24. A system to identify whether an offer is a deal, the system comprising:
a storage resource;
a network module; and
a processor communicatively coupled to the storage resource and the network module, wherein the processor executes application code instructions that are stored in the storage resource and that cause the system to:
monitor a plurality of offers for a product during a configured time period, each of the offers comprising a price for the product and a time during which the respective offer is valid;
select a current offer for the product, the current offer comprising a price for the product and a time during which current offer is valid;
identify the offers for the product in the database that are within a configured time period of the current offer;
determine an average price for the product, wherein the average price is an average of the prices of the offers that are within the configured time period of the current offer;
determine if the price of the current offer is less than a configured threshold below the average price;
identify the current offer as a deal in response to a determination that the current offer is less than a configured threshold below the average price; and
identifying, by the computer, the current offer as not being a deal in response to a determination that the current offer is not less than a configured threshold below the average price.

25. The system of claim 24, the instructions further causing the system to:
receive a shopping query from a user network device, wherein the query is associated with the product; and
communicate the current offer identified as a deal to the user network device in response to receiving the query.

26. The system of claim 24, wherein the threshold is a configured percentage of the average price, is a configured dollar value less than the average price, or is equal to the average price.

27. The system of claim 24, wherein the network module transmits the current offer to a network device of a user in response to an identification of the current offer as a deal.

28. The system of claim 24, wherein the current offer identified as a deal is transferred to the network device of the user based on a determination that the product is related to the history of the user or an identified preference of the user.
